(19) United States
(12) Patent Application Publication
(10) Pub. No.: US 2024/0186934 A1
(43) Pub. Date: Jun. 6, 2024

(54) ELECTRIC POWER CONVERTER FOR PROVIDING ELECTRIC POWER TO AT LEAST ONE ELECTRIC DEVICE AND METHOD FOR OPERATING THE ELECTRIC POWER CONVERTER

(71) Applicant: Vacon Oy, Vaasa (FI)

(72) Inventors: Jani Perkiö, Tampere (FI); Dainius Stasiunas, Vaasa (FI)

(21) Appl. No.: 18/527,572

(22) Filed: Dec. 4, 2023

(30) Foreign Application Priority Data
Dec. 5, 2022 (DE) 102022132233.5

(51) Int. Cl. H02P 29/024; H02P 27/08

(52) U.S. Cl. CPC H02P 29/027; H02P 27/08

(57) ABSTRACT

An electric drive for driving at least one power converter and/or electric motor, having a mains supply connection for providing electric power to the electric drive, a redundant feeding system comprising at least two feeding units, namely a first non-regenerative front end or active front end and a second non-regenerative front end or active front end, power electronics components for connecting the mains supply connection to the feeding system, a control system for controlling the feeding system, and a DC-link connection for connecting the electric drive to a DC-link. The disclosure further discloses a method for operating a corresponding electric drive.

### CROSS-REFERENCE TO RELATED APPLICATION

This application claims foreign priority benefits under 35 U.S.C. § 119 from German Patent Application No. 102022132233.5, filed Dec. 5, 2022, the content of which is hereby incorporated by reference in its entirety.

### TECHNICAL FIELD

The present invention pertains to an electric drive, in particular a variable frequency drive (VFD), for driving at least one electric motor, comprising a mains supply connection for providing electric power to the electric drive, a redundant feeding system comprising a plural number and at least two feeding units, namely a first non-regenerative front end (NFE) or active front end (AFE) and a second non-regenerative front end or active front end, power electronics components for connecting the mains supply connection to the feeding system, a control system for controlling the feeding system, and a DC-link connection for connecting the electric drive to a DC-link. The invention is also directed at a method for operating a corresponding electric drive.

### BACKGROUND

Electric drives are used for driving electric motors. Certain electric drives may require redundant components such as feeding units. Such systems may usually be used in places where process up-time is critical and redundancy is needed to make sure that the process does not stop even in a case of a feeding unit failure. Both, the feeding units and further components of the electric drives may be connected to a DC-link bus bar connecting the components of the electric drive to a DC current source. Said DC-link bus bar has to be dimensioned to be able to carry the full load of the connected components and in particular the connected feeding units.

For example, if a motor driven by the electric drive requires a 1 kA load current as a power supply, two redundant feeding units may be required, each capable of feeding 1 kA into the DC-link bus bar. In case of e.g. a malfunction of the drive, the total current passing through the two feeding units in parallel makes it necessary to dimension the DC-link bus bar such that it can carry 2 kA. This means that making redundant systems requires larger bus bars and therefore increases bus bar costs. This is particularly problematic when components of the DC-link bus bar, such as copper, are expensive.

### SUMMARY

The aim of the present invention is to overcome this problem. The problem is solved by an improved electric drive according to claim 1 end a method for operating said drive according to claim 7. Advantageous embodiments of the invention are subject to the subclaims.

According to claim one an electric drive for driving at least one electric motor is provided. The drive comprises a mains supply connection for providing electric power to the electric drive, a redundant feeding system comprising at least two feeding units, namely a first non-regenerative front end or active front end and a second non-regenerative front end or active front end, power electronics components for connecting the mains supply connection to the feeding system, a control system for controlling the feeding system, and a DC-link connection for connecting the electric drive to a DC-link. According to the invention, the control system is provided to limit an over-current and/or over-load passing through the feeding system by creating a trip signal for disconnecting the feeding system at least partially from the power electronic components of the electric drive.

The invention makes it possible to create a redundant feeding system without the need for increasing the current capability of the DC-link bus bar and with-out the requirement for excessive additional hardware components. The invention provides redundant feeding units with current limiting and/or circuit opening capabilities for limiting the total DC-link current. This reduces the system costs of the electric drive as expensive materials such as copper are required in smaller quantities and no additional current limiting devices are necessary.

The power converter may provide power to any electric device such as an electric motor. Although use of the power converter in combination with a motor is preferred, the invention is not limited to this case. The power converter may be used in combination with e.g. three feeding units and/or energy storage devices such as batteries connected to the DC-link. In this case, no motor drives may be connected to the system. Still, a redundant power converter is provided, which solves the same problem, i.e. an oversized DC busbar, assuming that a battery would accept one feeding unit size current at most.

In a preferred embodiment of the invention, the over-current and/or overload are limited to remain under a defined maximum level. Clearly, this maximum level may be chosen depending on the maximum current the DC-link bus bar is capable of supporting.

In another preferred embodiment of the invention, the control system comprises one star board and a first control device, wherein the first control device controls the feeding units via the star board and the star board comprises a current limit function.

The control system may comprise a programmable over current and/or overload limiting function, creating a trip signal, which may open the circuit from the grid. The circuit can be opened with a non-regenerative front end, which may comprise thyristors in both, high and low legs. If an active front end is used for controlling a main contactor of the electric drive, then the active front end may be able to open the circuit additionally or alternatively.

In another preferred embodiment of the invention, the control system comprises at least a first control device and a second control device, wherein each feeding unit is controlled by a different control device.

In a particularly preferred embodiment of the invention, the control devices are connected to each other via a connection for communicating the currents passing through them.

In this case, the two or more control devices may comprise some control-to-control communication path for limiting the total current input into the DC-link bus bar.

In another preferred embodiment of the invention, the electronic components comprise main switches and/or contactors and/or transformers and/or filters.

The invention is also directed at a method according to claim 7 for operating an electric drive, comprising the steps of
establishing whether a current and/or load passing through the feeding system exceeds a value, and
creating a trip signal for disconnecting the feeding system at least partially from the power electronic components of the electric drive, if the current and/or load passing through the feeding system exceeds said value.

### BRIEF DESCRIPTION OF THE DRAWINGS

Further details and advantages of the invention are described with reference to the figures. In the figures, the DC-link current ratings are given as examples, the invention may be carried out with different current ratings. The figures show:

FIG. 1: an electric drive according to the state of the art and connected to two electric motors;

FIG. 2: a first embodiment of the electric drive;

FIG. 3: a second embodiment of the electric drive;

FIG. 4: an active front end using active switches;

FIG. 5: an active front end using thyristors as rectifiers;

FIG. 6: an active front end with a typical LC input filter;

FIG. 7: an active front end with contactor, circuit breaker, filter; and

FIG. 8: an INU (inverter unit).

### DETAILED DESCRIPTION

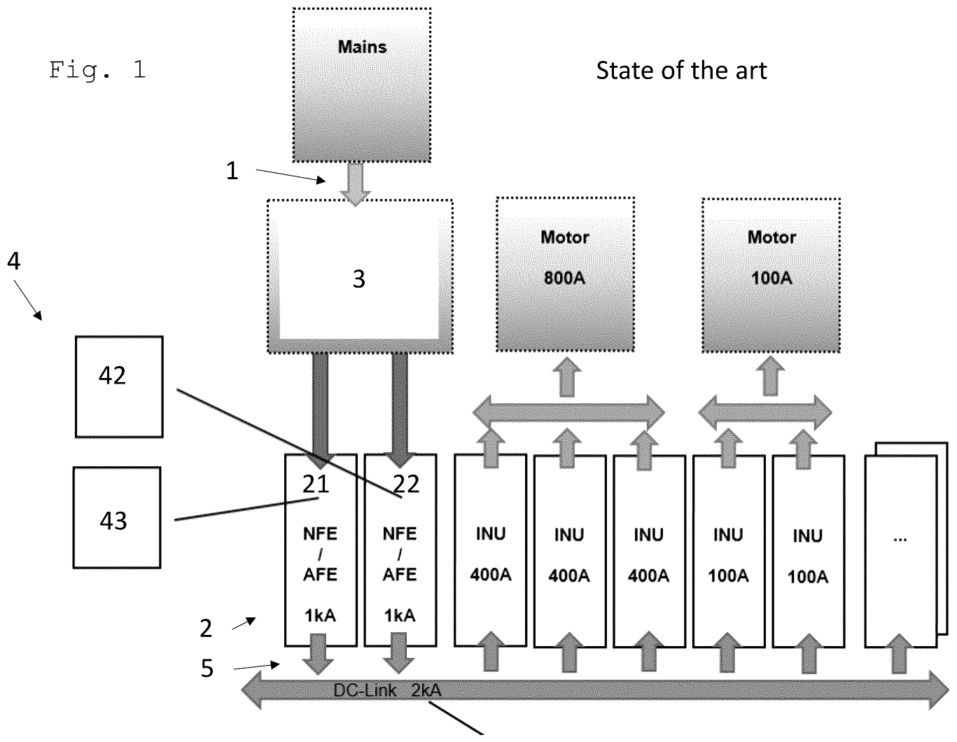

FIG. 1 shows an electric drive for driving electric motors according to the state of the art. The drive comprises a mains supply connection 1 for providing electric power to the electric drive, a redundant feeding system 2 comprising at least two feeding units 21, 22. Further components such as inverter units INU of various current ratings may also be provided. The feeding units 21, 22 of the drive may comprise a first non-regenerative front end NFE or active front end AFE and a second non-regenerative front end NFE or active front end AFE. The drive may further typically comprise other power electronics components 3 required for performing necessary current and voltage modifications and connecting the mains to the feeding system 2. A control system 4 comprising a first and second control device 42, 43 may be provided for controlling the feeding system 2. A DC-link connection 5 connects the electric drive to a DC-link. As the overload current form the feeding system 2 to the DC-link bus bar is not limited, the DC-link must be dimensioned according to the current limited by the feeding units and protection components, such as fuses.

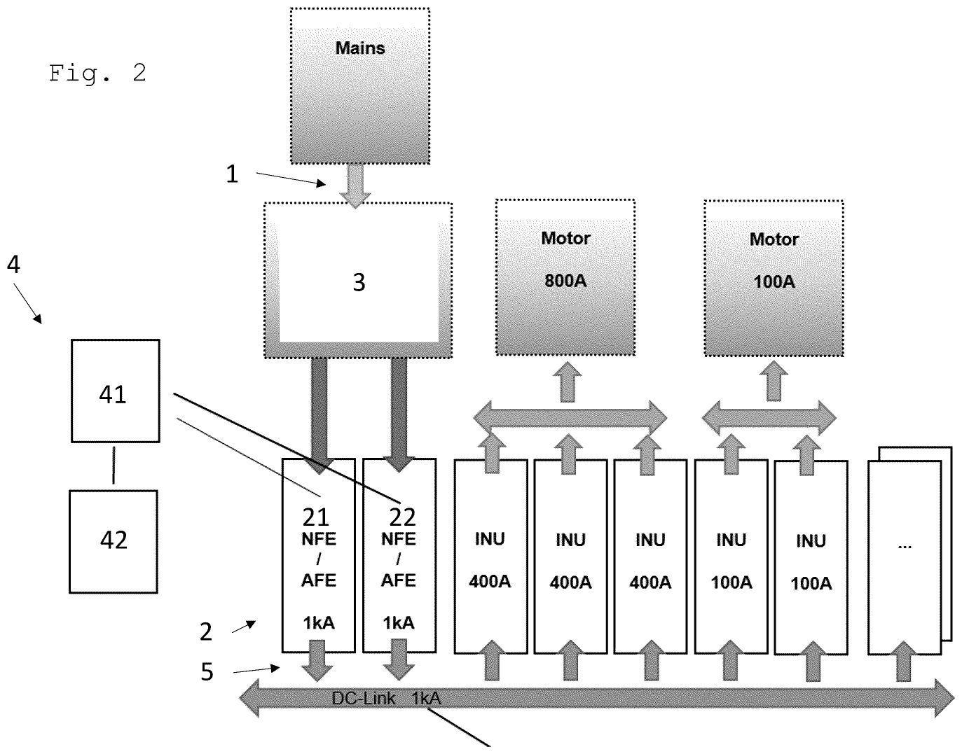

FIG. 2 shows a first embodiment of the electric drive. The drive comprises a control system 4 for limiting an over-current and/or overload passing through the feeding system 2 by creating a trip signal for disconnecting the feeding system 2 at least partially from the power electronic components 3 of the electric drive. The control system 4 may comprise some software based monitoring function which controls the currents passing through the feeding system 2.

Once an excessive current has been detected, the trip signal may be provided to the feeding system 3 or to some components of the feeding system 3, such that they are at least partially disconnected from the power electronic components 3 and/or the DC-link bus bar.

Thus, the electric drive may ensure that the over-current and/or overload occurring at the feeding system are limited to remain under a defined maximum level.

In the embodiment of FIG. 2, the control system 4 comprises one star board 41 and a first control device 42, wherein the first control device 42 controls both or all of the feeding units 21, 22 via the star board 41 Thus, a current limit function may be provided by the star board 41. Since an overload current is limited in this case by the feeding units control device 42, the DC-link can be dimensioned according to the current limit of the feeding system 3.

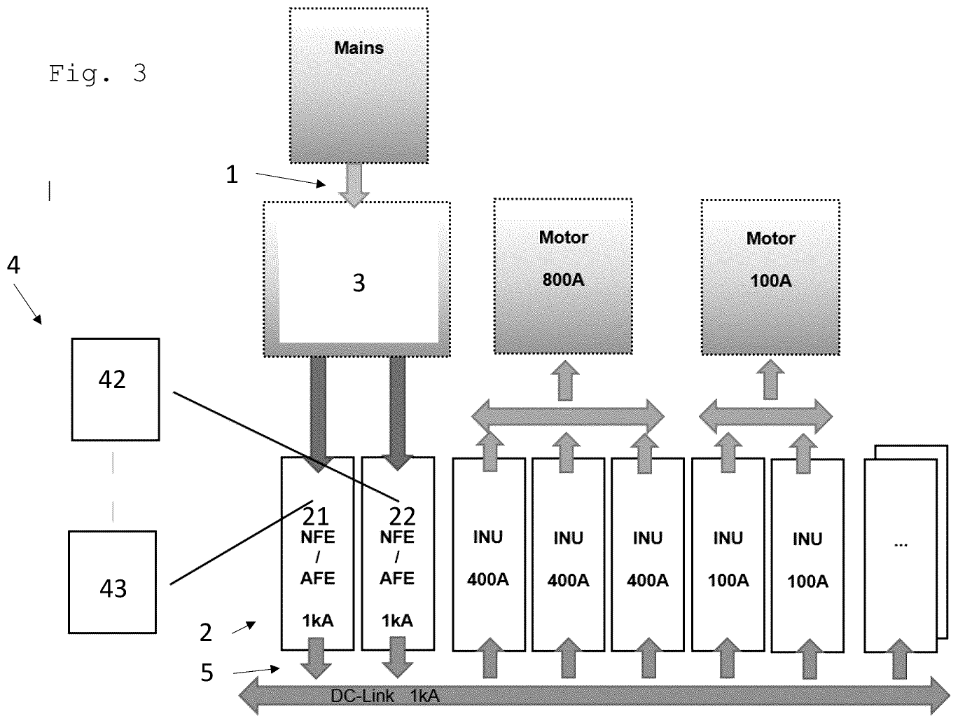

FIG. 3 shows a second embodiment of the electric drive. Here, the control system 4 comprises at least a first control device 42 and a second control device 43. The second control device 43 is different from the star board 41 described in the first embodiment shown in FIG. 2. In the second embodiment of FIG. 3, each feeding unit 21, 22 is controlled by a different control device 42, 43. The control devices 42, 43 are connected via a connection 6 to each other for communicating the currents passing through the components they control. They may be programmed or controlled to verify whether a maximum current value passing through the feeding units 21, 22 has been exceeded and/or to disconnect the feeding units 21, 22 from the DC-link bus bar and/or other components of the electric drive accordingly.

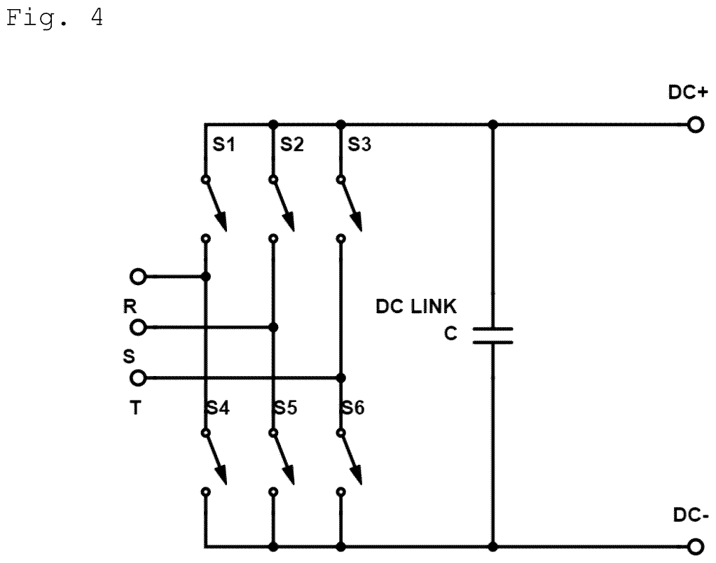

FIG. 4 shows an active front end using upper arm switches S1, S2, S3 and lower arm switches S4, S5, S6 to control the power conversion. Because of the switches S1 to S6, the power conversion may be bidirectional. DC+ and DC− may supply voltage to the DC-link bus bar. Capacitor C may reduce ripple on the DC link voltage.

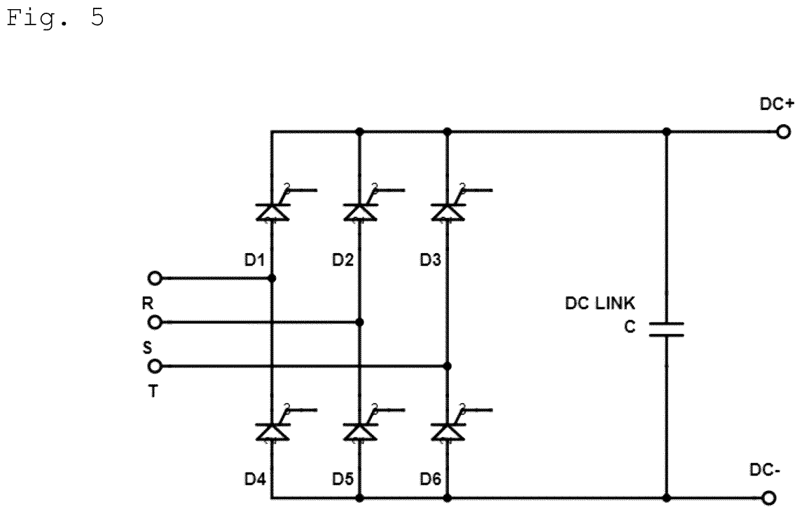

FIG. 5 shows an active front end using upper arm thyristors D1, D2, D3 and/or lower arm switches D4, D5, D6 to control the switching of power conversion. Phase AC input may be connected to grid via connectors R, S, T. DC+ and DC− may supply voltage to the DC-link bus bar. Capacitor C may reduce ripple on the DC link voltage.

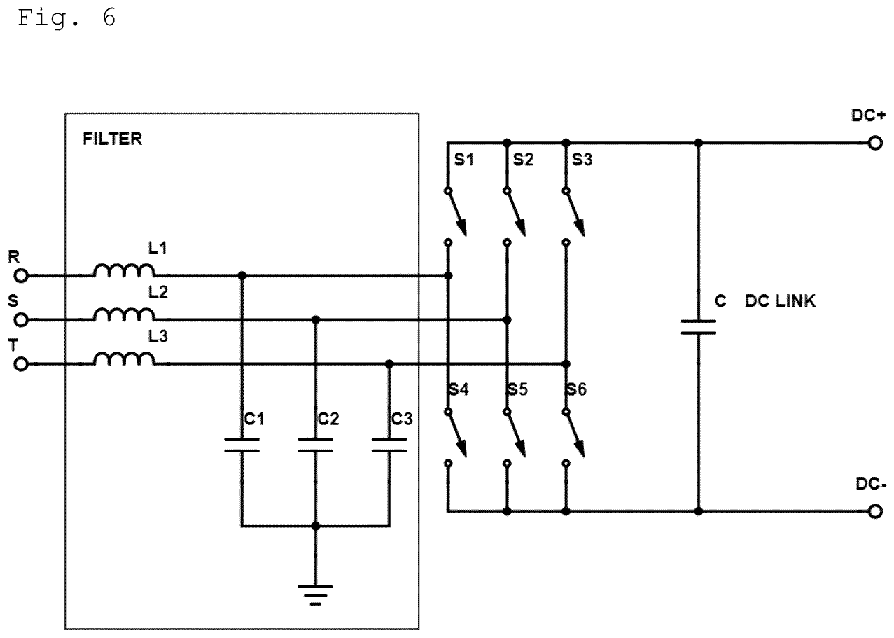

FIG. 6 shows an active front end using upper and lower arm switches S1, S2, S3, S4, S5, S6 and having an AC input filter coupled inductors L1, L2, L3 between grid R, S, T and midpoints S1-S4, S2-S5, S3-S6. Capacitors C1, C2, C3 may be coupled between midpoints S1-S4, S2-S5, S3-S6 and to, say, ground, for filtering Common Mode or, say, Differential Mode noise, caused by e.g. the switches S1 to S6 in operation.

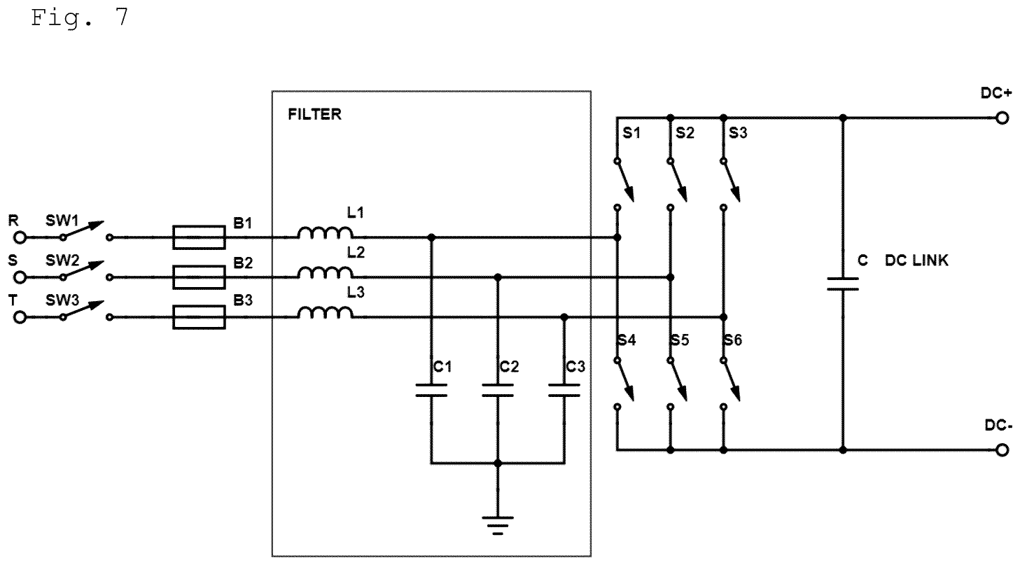

FIG. 7 shows an active front end with filter having circuit breakers SW1, SW2, SW3 to interrupt the power conversion and electrical connection between the grid R, S, T and the active front end circuitry as such. B1, B2, B3, may be used as circuit breakers in the event of exceeding a current limit (overcurrent) during, say, fault condition.

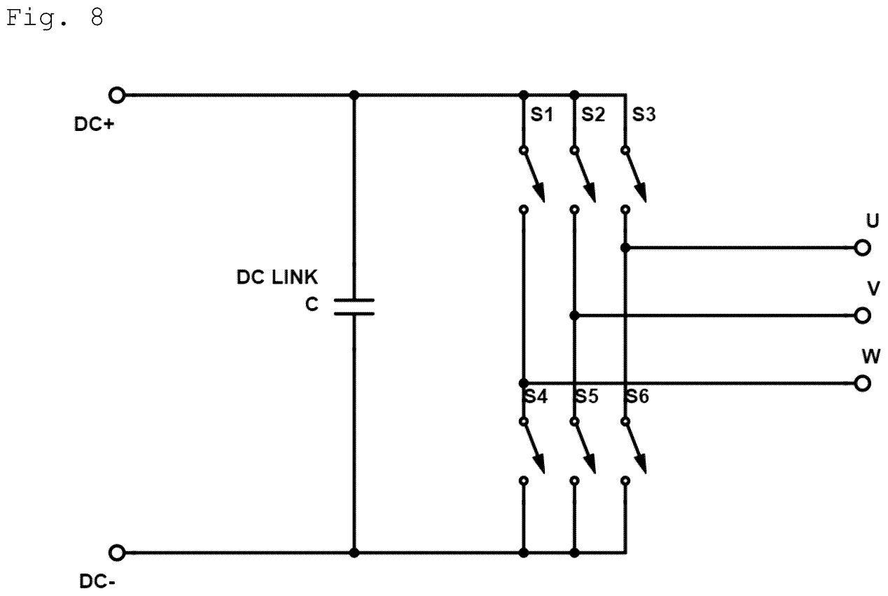

FIG. 8 shows an inverter INU having upper arm switches S1, S2, S3 and lower arm switches S4, S5, S6. The controlling of the switches may be Pulse Width Modulation. The power conversion may be bidirectional, which means a power from DC link bus is converted to say an AC voltage via switches S1 to S6 to connector U, V, W. The power may also flow from U, V, W connectors back into the DC link bus via switches S1 to S6.

Circuit breakers B1, B2, B3 may be used in the event of an overcurrent for de-coupling the power conversion and moreover the active front end from the supply grid. The overcurrent may be a fault condition, which triggers the circuit breakers B1, B2, B3.

The INU of FIG. 8 may also trigger the circuit breakers B1, B2, B3 by controlling the switches S1 to S6 in upper- and lower arm to an ON-state, causing a short circuit between DC+ and DC− and thereby triggering the circuit breakers B1, B2, B3. This controlled method of triggering the circuit breakers B1, B2, B3 by setting the upper- and lower arm switches S1 to S6 to ON at the same time may be initiated by any type a fault detecting which requires a safe stopping of the power conversion.

The electronic components 3 of the electric drive may comprise main switches, contactors, transformers, filters, communication devices and/or other components required for driving the motors.

The electric drive may be operated by a method comprising the steps of
establishing whether a current and/or load passing through the feeding system 2 exceeds a value, and
creating a trip signal for disconnecting the feeding system 2 at least partially from the power electronic components 3 of the electric drive, if the current and/or load passing through the feeding system 2 exceeds said value.

The method may be implemented by a control algorithm, wherein the control system 4 or components thereof are programmed to monitor the currents passing through the feeding system. The method may include further steps related to the functioning and control of the presently described components of the electric drive. The invention may comprise any logical combinations of features of the presently described embodiments.

What is claimed is:

1. An electric power converter for providing electric power to at least one electric device, such as an electric motor, comprising a mains supply connection for providing electric power to the power converter, a redundant feeding system comprising at least two feeding units, namely a first non-regenerative front end (NFE) or active front end (NFE) and a second non-regenerative front end (NFE) or active front end (NFE), power electronics components for connecting the mains supply connection to the feeding system, a control system for controlling the feeding system, and a DC-link connection for connecting the power converter to a DC-link, wherein the control system is provided to limit an over-current and/or overload passing through the feeding system by creating a trip signal for disconnecting the feeding system at least partially from the power electronic components of the power converter.

2. The electric drive according to claim 1, wherein the over-current and/or overload are limited to remain under a defined maximum level.

3. The electric drive according to claim 1, wherein the control system comprises one star board and a first control device, wherein the first control device controls the feeding units via the star board and the star board comprises a current limit function.

4. The electric drive according to claim 1, wherein the control system comprises at least a first control device and a second control device, wherein each feeding unit is controlled by a different control device.

5. The electric drive according to claim 4, wherein the control devices are connected via a connection to each other for communicating the currents passing through them.

6. The electric drive according to claim 1, wherein the electronic components comprise main switches and/or contactors and/or transformers and/or filters.

7. A method for operating the electric drive according to claim 1, wherein it comprises the steps of
establishing whether a current and/or load passing through the feeding system exceeds a value, and
creating a trip signal for disconnecting the feeding system at least partially from the power electronic components of the electric drive, if the current and/or load passing through the feeding system exceeds said value.

8. The electric drive according to claim 2, wherein the control system comprises one star board and a first control device, wherein the first control device controls the feeding units via the star board and the star board comprises a current limit function.

9. The electric drive according to claim 2, wherein the control system comprises at least a first control device and a second control device, wherein each feeding unit is controlled by a different control device.

10. The electric drive according to claim 2, wherein the electronic components comprise main switches and/or contactors and/or transformers and/or filters.

11. The electric drive according to claim 3, wherein the electronic components comprise main switches and/or contactors and/or transformers and/or filters.

12. The electric drive according to claim 4, wherein the electronic components comprise main switches and/or contactors and/or transformers and/or filters.

13. The electric drive according to claim 5, wherein the electronic components comprise main switches and/or contactors and/or transformers and/or filters.

14. A method for operating the electric drive according to claim 2, wherein it comprises the steps of
establishing whether a current and/or load passing through the feeding system exceeds a value, and
creating a trip signal for disconnecting the feeding system at least partially from the power electronic components of the electric drive, if the current and/or load passing through the feeding system exceeds said value.

15. A method for operating the electric drive according to claim 3, wherein it comprises the steps of
establishing whether a current and/or load passing through the feeding system exceeds a value, and
creating a trip signal for disconnecting the feeding system at least partially from the power electronic components of the electric drive, if the current and/or load passing through the feeding system exceeds said value.

16. A method for operating the electric drive according to claim 4, wherein it comprises the steps of
establishing whether a current and/or load passing through the feeding system exceeds a value, and
creating a trip signal for disconnecting the feeding system at least partially from the power electronic components of the electric drive, if the current and/or load passing through the feeding system exceeds said value.

17. A method for operating the electric drive according to claim 5, wherein it comprises the steps of
establishing whether a current and/or load passing through the feeding system exceeds a value, and
creating a trip signal for disconnecting the feeding system at least partially from the power electronic components of the electric drive, if the current and/or load passing through the feeding system exceeds said value.

18. A method for operating the electric drive according to claim 6, wherein it comprises the steps of
establishing whether a current and/or load passing through the feeding system exceeds a value, and
creating a trip signal for disconnecting the feeding system at least partially from the power electronic components of the electric drive, if the current and/or load passing through the feeding system exceeds said value.
